(19) United States
(12) Patent Application Publication
(10) Pub. No.: US 2015/0172762 A1
(43) Pub. Date: Jun. 18, 2015

(54) CONTENT TRANSMISSION DEVICE, CONTENT PLAYBACK DEVICE, CONTENT DELIVERY SYSTEM, CONTROL METHOD FOR CONTENT TRANSMISSION DEVICE, CONTROL METHOD FOR CONTENT PLAYBACK DEVICE, DATA STRUCTURE, CONTROL PROGRAM, AND RECORDING MEDIUM

(71) Applicant: Sharp Kabushiki Kaisha, Osaka-shi, Osaka (JP)

(72) Inventors: Yasuaki Tokumo, Osaka-shi (JP); Shuichi Watanabe, Osaka-shi (JP); Takuya Iwanami, Osaka-shi (JP)

(21) Appl. No.: 14/413,068

(22) PCT Filed: Jul. 1, 2013
(86) PCT No.: PCT/JP2013/067983

§ 371 Date: Jan. 6, 2015

(30) Foreign Application Priority Data
Jul. 10, 2012 (JP) 2012-155076
Oct. 9, 2012 (JP) 2012-224169

(51) Int. Cl. H04N 21/462; H04N 21/858; H04N 21/6332; H04N 21/845; H04N 21/2387; H04N 21/24

(52) U.S. Cl. CPC H04N 21/4622; H04N 21/2387; H04N 21/2405; H04N 21/6332; H04N 21/8456; H04N 21/8586; H04N 21/2402

(57) ABSTRACT

A server (1) transmitting content of an MPEG-DASH standard to a client (2), includes a throughput measurement section (23) that measures a throughput of the server (1), an event information addition section (24) that generates obtainment destination switching instruction information instructing to switch an obtainment destination of the content to another content transmission device when the throughput is a predetermined value or more, and a content transmission section (22) that transmits segment data together with the obtainment destination switching instruction information. Hereby, the most suitable adaptive streaming is executed in real time.

### TECHNICAL FIELD

The present invention relates to a content transmission device which transmits content, a content playback device which obtains and plays back content, a content delivery system, a control method for a content transmission device, a control method for a content playback device, a data structure, a control program, and a recording medium.

### BACKGROUND ART

In accordance with diffusion of the Internet and high performance of a computer, it has been widely performed to deliver a large capacity content such as a moving image through the Internet. For example, there is a service providing the content such as video depending on an asking of a user which is called VOD (Video On Demand). In the VOD, for example, as described in PTL 1, using HTTP (HyperText Transfer Protocol), data is transmitted and received between a server (content offer device) and a client (content playback device).

Here, in regard to delivery of the content by the HTTP, various technologies have been developed. For example, MPEG (Motion Picture Experts Group) pushes forward international standardization of an adaptive streaming technology using the HTTP as an MPEG-DASH (Dynamic Adaptive Streaming over HTTP) standard.

In the MPEG-DASH, the content is time-divided into a plurality of segments (segment), and is transmitted by a segment unit. Moreover, each segment is configured of one fragment or a plurality of fragments (fragment). Additionally, the content is configured of one period or a plurality of periods (period), and in one period, one segment is included or the plurality of segments are included.

Moreover, in the MPEG-DASH, a plurality of Representations of which quality classification (classification of bit rate, playback quality such as image resolution, data format, or the like) with respect to one content is different, are prepared. For example, a plurality of segment data which is encoded at a different bit rate per segment, are prepared. Hereby, a client that receives and plays back the content, can execute the adaptive streaming, by changing the bit rate of the asked content (segment), depending on a reception condition of the content, or the like.

Additionally, in the MPEG-DASH, the content (segment) of which contents and the quality type are the same may be provided by a plurality of servers. Hereby, the client is capable of switching an obtainment destination of the content depending on the reception condition of the content, or the like.

For example, as shown in FIG. 14, a first server 101 and a second server 102 obtain segment data and MPD data respectively, from a segment storage device 106 storing the segment data which is a data main body of the content, and an MPD storage device 105 storing the MPD data (described later in detail) which is management information of the content, through a network. In this case, a client 103 can switch an asking destination of the content to the first server 101 or the second server 102, depending on the reception condition of the content, or the like. Furthermore, the first server 101 and the second server 102 may locally retain the segment data and the MPD data, respectively.

Moreover, in the MPEG-DASH, MPD (Media Presentation Description) is associated with the content, and the content is managed by the MPD. The MPD is metadata of the content, and is obtained by describing the management information of the content in an XML form. In other words, the MPD is information which is used by the client at the time of the obtainment and the playback of the content.

A specific description example of the MPD will be described on the basis of FIG. 15. FIG. 15 is a diagram illustrating the description example of the MPD. As shown in FIG. 15, in an MPD 200, obtainment destination information 201 indicating the obtainment destination of the content is described. More specifically, in the example shown in FIG. 15, as obtainment destination information 201, a URL of the server is described. Additionally, here, the URLs of two servers (cdn 1 and cdn 2) are described, and as described above, the client is capable of selecting the obtainment destination of the content, by referring to the MPD 200.

Moreover, here, as content, it is assumed that the high quality Representation of which the bit rate is 1024 kbps, and the low quality Representation of which the bit rate is 512 kbps, are used. Therefore, as a segment which is included in the MPD 200, or in a certain period (playback time which is from 0 second until 600 seconds), a high quality segment information 202 indicating the high quality segment, and a low quality segment information 203 indicating the low quality segment are described. In the high quality segment information 202, ID and the bit rate of the high quality Representation which is included in the period, are described. Still more, a length and the URL of each segment which is included in the period, are described. Additionally, also the low quality segment information 203 is similar thereto. Therefore, the period is configured of 60 segments of a first segment to a sixtieth segment.

Next, an operation sequence and an HTTP message in a case of switching the server based on the reception condition of the content, will be described on the basis of FIG. 16 and FIG. 17. FIG. 16 is a diagram illustrating an example of the operation sequence in the case of switching the server based on the reception condition of the content. Moreover, FIG. 17 is a diagram illustrating an example of the HTTP message in the case of switching the server based on the reception condition of the content.

Here, as shown in FIG. 14, the first server 101 and the second server 102 obtain the segment data and the MPD data from the segment storage device 106 and the MPD storage device 105 respectively, and the client 103 is capable of switching the asking destination of the content to the first server (cdn 1) 101 or the second server (cdn 2) 102. Additionally, the MPD 200 shown in FIG. 15, is associated with the content.

As shown in FIG. 16 and FIG. 17, first, the client 103 refers to the MPD 200, and transmits a request message 301 for asking for transmission of an N-th segment to the first server 101. The first server 101 transmits a response message 302 including the data main body of the N-th segment to the client 103, as an answer of the request message 301.

Here, if deterioration of the reception condition is detected at the time of receiving the N-th segment (processing 303), the client 103 refers to the MPD 200, and performs a search of an alternative server (processing 304). Here, since the second server 102 is described in the MPD 200, the client 103 refers to the MPD 200, and transmits a request message 305 for asking for the transmission of the following (N+1)-th segment to the second server 102, to the second server 102. The second server 102 transmits a response message 306 including the data main body of the (N+1)-th segment to the client 103, as an answer of the request message 305.

Next, the operation sequence and the HTTP message in a case (case of switching the obtained Representation) of switching the quality classification of the content which is obtained based on the reception condition of the content, will be described on the basis of FIG. 18 and FIG. 19. FIG. 18 is a diagram illustrating an example of the operation sequence in the case of switching the quality classification of the content which is obtained based on the reception condition of the content. Moreover, FIG. 19 is a diagram illustrating an example of the HTTP message in the case of switching the quality classification of the content which is obtained based on the reception condition of the content.

Here, the MPD 200 shown in FIG. 15, is associated with the content, and the client 103 obtains the high quality Representation (rep 1) or the low quality Representation (rep 2), from the first server (cdn 1) 101, depending on the reception condition.

As shown in FIG. 18 and FIG. 19, first, the client 103 refers to the MPD 200, and transmits a request message 311 for asking for the transmission of the N-th segment of the high quality Representation to the first server 101. The first server 101 transmits a response message 312 including the data main body of the N-th segment of the high quality Representation to the client 103, as an answer of the request message 311.

Here, if the deterioration of the reception condition is detected at the time of receiving the N-th segment of the high quality Representation (processing 313), the client 103 refers to the MPD 200, and performs the search of an alternative Representation (processing 314). Here, since the low quality Representation (rep 2) as an alternative Representation is described in the MPD 200, the client 103 refers to the MPD 200, and transmits a request message 315 for asking for the transmission of the (N+1)-th segment of the low quality Representation to the first server 101, to the first server 101. The first server 101 transmits a response message 316 including the data main body of the (N+1)-th segment of the low quality Representation to the client 103, as an answer of the request message 315.

### CITATION LIST

### Patent Literature

PTL 1: Japanese Unexamined Patent Application

Publication No. 2005-110244 (published on Apr. 21, 2005)

### Non Patent Literature

NPL 1: “ISO/IEC 23009-1”, [online], Apr. 1, 2012, ISO/IEC, [searched on Jun. 19, 2012], internet <URL:http://standards.iso.org/ittf/PubliclyAvailableStandard s/c057623_ISO_IEC_{—}23009-1_{—}2012.zip>

NPL 2: “ISO/IEC 14496-12”, Oct. 15, 2008, ISO/IEC

### SUMMARY OF INVENTION

### Technical Problem

However, in the operation sequence described above, when the client detects the deterioration of the reception condition of the content, it may not be determined whether the deterioration is caused by a processing delay of the server, or whether the deterioration is caused by a band lack of the network. Therefore, there is a problem that it may not be appropriately determined whether it is favorable if either of the server switching, or the Representation switching is performed, as a correspondence with respect to the deterioration of the reception condition of the content.

Moreover, by an update of the MPD (delivery of the renewed MPD to which the URL of the alternative server is added, or delivery of the renewed MPD where a description order of the URL of the alternative server is changed, or the like), when the server switching is realized, the delay in accordance with the MPD update processing may not be avoided in the client, that is, there is the problem that real time properties are low.

Specifically, on the basis of FIG. 20 to FIG. 22, by the update of the MPD, the case of realizing the server switching will be described. FIG. 20 is a diagram illustrating an example of the operation sequence in the case of realizing the server switching, by the update of the MPD. FIG. 21 is a diagram illustrating the MPD before the MPD update, and FIG. 22 is a diagram illustrating the MPD after the MPD update.

Here, if the first server 101 is in a high load state where the requests are concentrated, the URL of the second server 102 is described in the MPD, the MPD is updated, and the client 103 is prompted so as to switch the first server 101 to the second server 102. Additionally, the client 103 confirms presence or absence of the update of the MPD at predetermined intervals (per 60 seconds).

As shown in FIG. 20 to FIG. 22, the client 103 performs the confirmation (polling) of the MPD update presence or absence with respect to the first server 101, in parallel with the obtainment processing of the content on the basis of the MPD shown in FIG. 21 (processing 401). Here, since the MPD is not updated, the first server 101 notifies no update of the MPD, with respect to the client 103 (processing 402).

Thereafter, since the requests are concentrated on the first server 101, and the first server 101 is in the high load state, the first server 101 generates the MPD shown in FIG. 22 where the URL of the second server 102 is described, and updates the MPD (processing 403).

The client 103 performs the confirmation of the MPD update presence or absence with respect to the first server 101, at a timing of the following update confirmation (processing 404). At this time, since the MPD is updated, the first server 101 transmits the updated MPD to the client 103 (processing 405). Therefore, the client 103 refers to the updated MPD, and changes the obtainment destination of the content into the second server 102.

In this manner, from that the first server 101 is in the high load state, the client 103 does not immediately switch the first server 101 to the second server 102, and the delay is generated, depending on an MPD update confirmation interval. Additionally, when the MPD update confirmation interval is set to be short, there is the problem that the processing of the client 103 and the processing of the first server 101 are enlarged, and even when there is no update of the MPD, since an exchange of the data (for example, HTTP message) in accordance with the polling frequently occurs, there is the problem that the network band is pressed.

The present invention is made in view of the above problems, and an object thereof is to realize a content transmission device, a content playback device, a content delivery system, a control method for a content transmission device, a control method for a content playback device, a data structure, a control program, and a recording medium which execute the most suitable adaptive streaming in real time.

### Solution to Problem

In order to solve the above problems, the present invention provides a content transmission device that transmits content which is configured of a plurality of segments to a content playback device per segment, including a transmission unit that transmits a response including the segment to the content playback device, as an answer with respect to a request asking for transmission of each segment from the content playback device, a throughput measurement unit that measures a throughput of the content transmission device, and an information generation unit that generates acquirement destination switching instruction information instructing to switch an obtainment destination of the content to another content transmission device, in a case of the most recent throughput which is measured by the throughput measurement unit of a predetermined value or more, in which in a case of generating the obtainment destination switching instruction information by the information generation unit, the transmission unit transmits the segment together with the obtainment destination switching instruction information which is generated by the information generation unit.

In order to solve the above problems, the present invention provides a control method for a content transmission device that transmits content which is configured of a plurality of segments to a content playback device per segment, including transmitting a response including the segment to the content playback device, as an answer with respect to a request asking for transmission of each segment from the content playback device, measuring a throughput of the content transmission device, and generating obtainment destination switching instruction information instructing to switch an obtainment destination of the content to another content transmission device, in a case of the most recent throughput which is measured in the measuring the throughput of a predetermined value or more, in which in a case of generating the obtainment destination switching instruction information in the generating the information, the transmitting transmits the segment together with the obtainment destination switching instruction information which is generated in the generating the information.

According to the above configurations, when the throughput of the content transmission device is the predetermined value or more (that is, in a case of being in a high load state), the content transmission device can instruct the content playback device to switch the obtainment destination of the content to another content transmission device, at the time of obtaining the segment by the content playback device. Therefore, when the content transmission device is in the high load state, the content playback device can find out a cause of deterioration of a reception condition of the segment in real time.

Accordingly, the content transmission device has an effect that the most suitable adaptive streaming can be executed in real time, on the content playback device.

The present invention provides the content transmission device, in which it is preferable that the information generation unit add the obtainment destination switching instruction information to a header portion of the segment.

The present invention provides the content transmission device, in which it is preferable that the information generation unit add the obtainment destination switching instruction information to a header of the response.

The present invention provides the content transmission device, in which it is preferable that in the case of the most recent throughput which is measured by the throughput measurement unit of a predetermined value or more, the information generation unit generate the obtainment destination switching instruction information instructing a timing of switching the obtainment destination of the content to another content transmission device depending on the throughput.

According to the above configurations, the content transmission device can instruct a timing of switching to another content transmission device, with respect to the content playback device, depending on the throughput of the content transmission device (that is, depending on a degree of the high load state). For example, when the content transmission device is in the high load state, but the degree thereof is low (when urgent properties are low), the content transmission device may instruct the content playback device to switch to another content transmission device from the time of the obtainment of the following segment, or from the time of the obtainment of the segment which is included in the following period. On the other hand, when the content transmission device is in the high load state, and the degree thereof is high (when the urgent properties are high), the content transmission device interrupts the present request, and may instruct the content playback device to immediately switch to another content transmission device. In this manner, the content transmission device can make the most suitable adaptive streaming be executed in real time, with respect to the content playback device, depending on the throughput of the content transmission device.

In order to solve the above problems, the present invention provides a content transmission device that transmits content which is configured of a plurality of segments to a content playback device per segment, including a transmission unit that transmits a response including the segment to the content playback device, as an answer with respect to a request asking for transmission of each segment from the content playback device, a throughput measurement unit that measures a throughput of the content transmission device, and an information generation unit that generates load state information indicating that the content transmission device is in a high load state, in a case of the throughput which is measured by the throughput measurement unit of a predetermined value or more, in which the transmission unit transmits the segment together with the most recent load state information which is generated by the information generation unit.

In order to solve the above problems, the present invention provides a control method for a content transmission device that transmits content which is configured of a plurality of segments to a content playback device per segment, including transmitting a response including the segment to the content playback device, as an answer with respect to a request asking for transmission of each segment from the content playback device, measuring a throughput of the content transmission device, and generating load state information indicating that the content transmission device is in a high load state, in a case of the throughput which is measured in the measuring the throughput of a predetermined value or more, in which the transmitting transmits the segment together with the most recent load state information which is generated in the generating the information.

According to the above configurations, when the throughput of the content transmission device is the predetermined value or more (that is, in the case of being in the high load state), the content transmission device can notify that the content transmission device is in the high load state, with respect to the content playback device, at the time of obtaining the segment by the content playback device. Therefore, when the content transmission device is in the high load state, the content playback device can find out the cause of the deterioration of the reception condition of the segment in real time. The content playback device receives the notification, and can switch the obtainment destination of the content to another content transmission device. Accordingly, the content transmission device has the effect that the most suitable adaptive streaming can be executed in real time, on the content playback device.

The present invention provides the content transmission device, in which it is preferable that the information generation unit add the load state information to a header portion of the segment.

The present invention provides the content transmission device, in which it is preferable that the information generation unit add the load state information to a header of the response.

The present invention provides the content transmission device, in which it is preferable that in the case of the throughput which is measured by the throughput measurement unit of a predetermined value or more, the information generation unit generate the load state information indicating a degree of the high load state of the content transmission device, depending on the throughput.

According to the above configurations, the content transmission device can notify the degree of the high load state of the content transmission device, with respect to the content playback device, depending on the content transmission device (that is, depending on the degree of the high load state). For example, in a case of notifying that the content transmission device is in the high load state, but the degree thereof is low (in a case of notifying that the urgent properties are low), the content playback device may make so as to switch to another content transmission device from the time of the obtainment of the following segment, or from the time of the obtainment of the segment which is included in the following period. On the other hand, in a case of notifying that the content transmission device is in the high load state, and the degree thereof is high (in a case of notifying that the urgent properties are high), the content playback device interrupts the present request, and may make so as to immediately switch to another content transmission device. In this manner, the content transmission device notifies the degree of the high load state of the content transmission device, and thereby, the content playback device can execute the most suitable adaptive streaming in real time.

In order to solve the above problems, the present invention provides a content playback device that obtains and plays back content which is configured of a plurality of segments from a content transmission device per segment, including an obtainment unit that transmits a request asking for transmission of each segment to the content transmission device, and obtains a response including the segment, as an answer with respect to the request, in which in a case of obtaining obtainment destination switching instruction information instructing to switch an obtainment destination of the content to another content transmission device, the obtainment unit transmits the segment together with the request to another content transmission device.

In order to solve the above problems, the present invention provides a control method for a content playback device that obtains and plays back content which is configured of a plurality of segments from a content transmission device per segment, including transmitting a request asking for transmission of each segment to the content transmission device, and obtaining a response including the segment, as an answer with respect to the request, in which in a case of obtaining obtainment destination switching instruction information instructing to switch an obtainment destination of the content to another content transmission device, the obtaining transmits the segment together with the request to another content transmission device.

According to the above configurations, the content playback device can switch the obtainment destination of the content to another content transmission device, based on an instruction of the content transmission device, at the time of obtaining the segment from the content transmission device. Here, when the content transmission device is in the high load state, it is considered that the reception condition of the segment of the content playback device deteriorates. Accordingly, the content playback device has an effect of executing the most suitable adaptive streaming in real time, by switching the obtainment destination to another content transmission device which is different from the content transmission device, based on the instruction of the content transmission device.

The present invention provides the content playback device, in which it is preferable that in a case of adding the obtainment destination switching instruction information to a header portion of the segment, the obtainment unit transmit the request to another content transmission device.

The present invention provides the content playback device, in which it is preferable that in a case of adding the obtainment destination switching instruction information to a header of the response, the obtainment unit transmits the request to another content transmission device.

The present invention provides the content playback device, in which it is preferable that in a case of instructing a timing of switching the obtainment destination of the content to another content transmission device by the obtainment destination switching instruction information, the obtainment unit transmit the request to another content transmission device at the instructed timing.

According to the above configurations, the content playback device can switch the obtainment destination of the content to another content transmission device at the instructed timing, based on the instruction of the content transmission device, at the time of obtaining the segment from the content transmission device. For example, when the content transmission device is in the high load state, but the degree thereof is low (when the urgent properties are low), the content transmission device may instruct the content playback device to switch to another content transmission device from the time of the obtainment of the following segment, or from the time of the obtainment of the segment which is included in the following period. On the other hand, when the content transmission device is in the high load state, and the degree thereof is high (when the urgent properties are high), the content transmission device interrupts the present request, and may instruct the content playback device to immediately switch to another content transmission device. In this manner, the content playback device can execute the most suitable adaptive streaming in real time, depending on the throughput of the content transmission device, based on the instruction of the content transmission device.

In order to solve the above problems, the present invention provides a content playback device that obtains and plays back content which is configured of a plurality of segments from a content transmission device per segment, including an obtainment unit that transmits a request asking for transmission of each segment to the content transmission device, and obtains a response including the segment, as an answer with respect to the request, in which in a case of obtaining load state information indicating that the content transmission device is in a high load state, the obtainment unit transmits the segment together with the request to another content transmission device.

In order to solve the above problems, the present invention provides a control method for a content playback device that obtains and plays back content which is configured of a plurality of segments from a content transmission device per segment, including transmitting a request asking for transmission of each segment to the content transmission device, and obtaining a response including the segment, as an answer with respect to the request, in which in a case of obtaining load state information indicating that the content transmission device is in a high load state, the obtaining transmits the segment together with the request to another content transmission device.

According to the above configurations, the content playback device can switch the obtainment destination of the content to another content transmission device, based on the instruction of the content transmission device, at the time of obtaining the segment from the content transmission device. Here, when the content transmission device is in the high load state, it is considered that the reception condition of the segment of the content playback device deteriorates. Accordingly, the content playback device has an effect of executing the most suitable adaptive streaming in real time, by switching the obtainment destination to another content transmission device which is different from the content transmission device, based on presence or absence of the notification from the content transmission device.

The present invention provides the content playback device, in which it is preferable that in a case of adding the load state information to a header portion of the segment, the obtainment unit transmit the request to another content transmission device.

The present invention provides the content playback device, in which it is preferable that in a case of adding the load state information to a header of the response, the obtainment unit transmit the request to another content transmission device.

The present invention provides the content playback device, in which it is preferable that in a case of indicating a degree of the high load state of the content transmission device by the load state information, the obtainment unit transmit the request to another content transmission device at a predetermined timing depending on the degree.

According to the above configurations, the content playback device can find out the degree of the high load state of the content transmission device, at the time of obtaining the segment from the content transmission device. For example, when the content transmission device is in the high load state, but the degree thereof is low (when the urgent properties are low), the content playback device may make so as to switch to another content transmission device from the time of the obtainment of the following segment, or from the time of the obtainment of the segment which is included in the following period. On the other hand, when the content transmission device is in the high load state, and the degree thereof is high (when the urgent properties are high), the content playback device interrupts the present request, and may make so as to immediately switch to another content transmission device. In this manner, the content playback device can execute the most suitable adaptive streaming in real time, depending on the degree of the high load state of the content transmission device.

The present invention provides a content delivery system that is preferable to include the content transmission device, and the content playback device.

According to the above configuration, the content delivery system has the same effect as the content transmission device and the content playback device.

The scope of the present invention also includes a data structure of a plurality of segments that configures content which is obtained from a content transmission device by a content playback device, in which in a header portion of the segment, obtainment destination switching instruction information instructing to switch an obtainment destination of the content to another content transmission device, or load state information indicating that the content transmission device is in a high load state, is included.

The scope of the present invention also includes a data structure of a response including the segment that is an answer with respect to a request asking for transmission of each segment which configures content to a content transmission device by a content playback device, and is obtained by the content playback device, in which in a header of the response, obtainment destination switching instruction information instructing to switch an obtainment destination of the content to another content transmission device, or load state information indicating that the content transmission device is in a high load state, is included.

The content transmission device and the content playback device may be realized by a computer. In this case, the scope of the present invention also includes a control program which makes the content transmission device and the content playback device be realized by the computer, by causing the computer to operate as each unit of the content transmission device and the content playback device, and a computer readable recording medium recording the control program.

### Advantageous Effects of Invention

According to the present invention, a content transmission device includes a transmission unit that transmits a response including the segment to the content playback device, as an answer with respect to a request asking for transmission of each segment from the content playback device, a throughput measurement unit that measures a throughput of the content transmission device, and an information generation unit that generates obtainment destination switching instruction information instructing to switch an obtainment destination of the content to another content transmission device, in a case of the most recent throughput which is measured by the throughput measurement unit of a predetermined value or more, in which in a case of generating the obtainment destination switching instruction information by the information generation unit, the transmission unit transmits the segment together with the obtainment destination switching instruction information which is generated by the information generation unit.

According to the present invention, a control method for a content transmission device includes transmitting a response including the segment to the content playback device, as an answer with respect to a request asking for transmission of each segment from the content playback device, measuring a throughput of the content transmission device, and generating obtainment destination switching instruction information instructing to switch an obtainment destination of the content to another content transmission device, in a case of the most recent throughput which is measured in the measuring the throughput of a predetermined value or more, in which in a case of generating the obtainment destination switching instruction information in the generating the information, the transmitting transmits the segment together with the obtainment destination switching instruction information which is generated in the generating the information.

Accordingly, the content transmission device has an effect that the most suitable adaptive streaming can be executed in real time, on the content playback device.

According to the present invention, a content transmission device includes a transmission unit that transmits a response including the segment to the content playback device, as an answer with respect to a request asking for transmission of each segment from the content playback device, a throughput measurement unit that measures a throughput of the content transmission device, and an information generation unit that generates load state information indicating that the content transmission device is in a high load state, in a case of the throughput which is measured by the throughput measurement unit of a predetermined value or more, in which the transmission unit transmits the segment together with the most recent load state information which is generated by the information generation unit.

According to the present invention, a control method for a content transmission device includes transmitting a response including the segment to the content playback device, as an answer with respect to a request asking for transmission of each segment from the content playback device, measuring a throughput of the content transmission device, and generating load state information indicating that the content transmission device is in a high load state, in a case of the throughput which is measured in the measuring the throughput of a predetermined value or more, in which the transmitting transmits the segment together with the most recent load state information which is generated in the generating the information.

Accordingly, the content transmission device has the effect that the most suitable adaptive streaming can be executed in real time, on the content playback device.

According to the present invention, a content playback device includes an obtainment unit that transmits a request asking for transmission of each segment to the content transmission device, and obtains a response including the segment, as an answer with respect to the request, in which in a case of obtaining obtainment destination switching instruction information instructing to switch an obtainment destination of the content to another content transmission device, the obtainment unit transmits the segment together with the request to another content transmission device.

According to the present invention, a control method for a content playback device includes transmitting a request asking for transmission of each segment to the content transmission device, and obtaining a response including the segment, as an answer with respect to the request, in which in a case of obtaining obtainment destination switching instruction information instructing to switch an obtainment destination of the content to another content transmission device, the obtaining transmits the segment together with the request to another content transmission device.

Accordingly, the content playback device has an effect of executing the most suitable adaptive streaming in real time, by switching the obtainment destination to another content transmission device which is different from the content transmission device, based on an instruction of the content transmission device.

According to the present invention, a content playback device includes an obtainment unit that transmits a request asking for transmission of each segment to the content transmission device, and obtains a response including the segment, as an answer with respect to the request, in which in a case of obtaining load state information indicating that the content transmission device is in a high load state, the obtainment unit transmits the segment together with the request to another content transmission device.

According to the present invention, a control method for a content playback device includes transmitting a request asking for transmission of each segment to the content transmission device, and obtaining a response including the segment, as an answer with respect to the request, in which in a case of obtaining load state information indicating that the content transmission device is in a high load state, the obtaining transmits the segment together with the request to another content transmission device.

Accordingly, the content playback device has the effect of executing the most suitable adaptive streaming in real time, by switching the obtainment destination to another content transmission device which is different from the content transmission device, based on presence or absence of the notification from the content transmission device.

### BRIEF DESCRIPTION OF DRAWINGS

FIG. 1 is a block diagram illustrating an example of a configuration of a content delivery system according to an embodiment of the present invention.

FIG. 2 is a diagram illustrating an example of a configuration of a main portion of a server and a client which are included in the content delivery system.

FIG. 3 is a flowchart illustrating an example of content transmission processing of the server.

FIG. 4 is a flowchart illustrating an example of content obtainment processing of the client.

FIG. 5 is a diagram illustrating an example of an operation sequence in a case of adding event information to a segment data main body in a box form which is defined by ISOBFF, and switching to an alternative server on the basis of the event information.

FIG. 6 is a diagram illustrating an example of an HTTP message in the case of adding the event information to the segment data main body in the box form which is defined by ISOBFF, and switching to the alternative server on the basis of the event information.

FIG. 7 is a diagram illustrating a data structure of segment data of related art.

FIG. 8 is a diagram illustrating a data structure of segment data to which event information is added.

FIG. 9 is a diagram illustrating an example of syntax of the event information.

FIG. 10 is a diagram illustrating an example of semantics of the event information.

FIG. 11 is a diagram illustrating an example of an operation sequence in a case of describing event information in an HTTP header of an HTTP response message which transmits a segment data main body, and switching to an alternative server on the basis of the event information.

FIG. 12 is a diagram illustrating an example of an HTTP message in the case of describing the event information in the HTTP header of the HTTP response message which transmits the segment data main body, and switching to the alternative server on the basis of the event information.

FIG. 13 is a diagram illustrating another example of the HTTP message in the case of describing the event information in the HTTP header of the HTTP response message which transmits the segment data main body, and switching to the alternative server on the basis of the event information.

FIG. 14 is a block diagram illustrating an example of a configuration of a content delivery system according to the related art.

FIG. 15 is a diagram illustrating a description example of MPD.

FIG. 16 is a diagram illustrating an example of an operation sequence in a case of switching a server based on a reception condition of content.

FIG. 17 is a diagram illustrating an example of an HTTP message in the case of switching the server based on the reception condition of the content.

FIG. 18 is a diagram illustrating an example of an operation sequence in a case of switching quality classification of content which is obtained based on a reception condition of content.

FIG. 19 is a diagram illustrating an example of an HTTP message in the case of switching the quality classification of the content which is obtained based on the reception condition of the content.

FIG. 20 is a diagram illustrating an example of an operation sequence in a case of realizing server switching, by an update of the MPD.

FIG. 21 is a diagram illustrating the MPD before the MPD update.

FIG. 22 is a diagram illustrating the MPD after the MPD update.

FIG. 23 is a diagram illustrating a description example of the MPD.

FIG. 24 is a diagram illustrating an event list.

### DESCRIPTION OF EMBODIMENTS

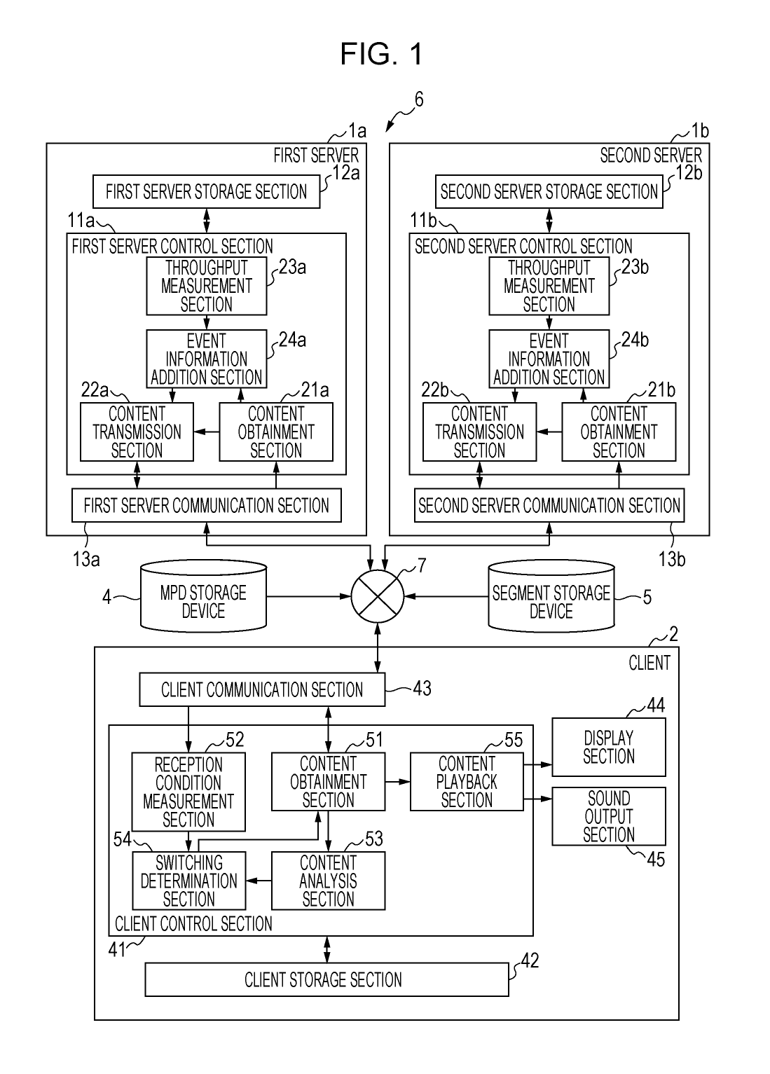

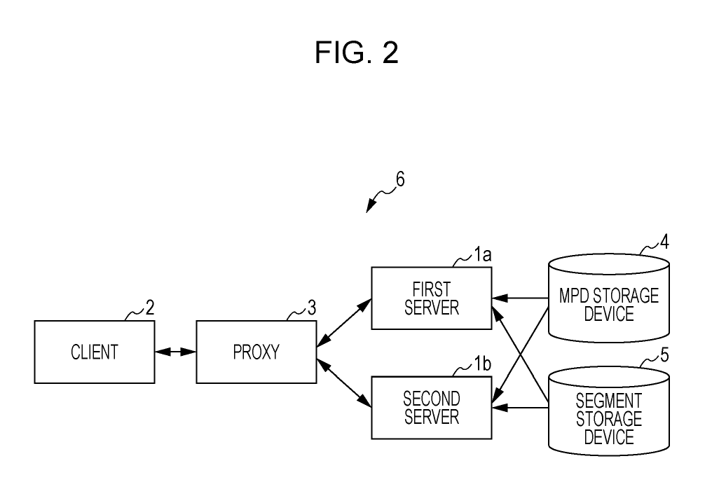

If an embodiment of the present invention will be described on the basis of FIG. 1 to FIG. 13, it is as follows. First, an outline of a content delivery system according to the embodiment, will be described on the basis of the FIG. 2.

### [Outline of Content Delivery System]

FIG. 2 is a diagram illustrating an outline of a content delivery system 6 according to the embodiment. As shown in FIG. 2, the content delivery system 6 includes a first server 1a, a second server 1b, a client 2, a proxy 3, an MPD storage device 4, and a segment storage device 5.

As shown in FIG. 2, the client 2 is connected to the first server 1a and the second server 1b, through the proxy 3. Moreover, the first server 1a and the second server 1b are connected to the MPD storage device 4 and the segment storage device 5, respectively. The respective devices are connected to each other by an arbitrary network of wire communication or wireless communication.

Furthermore, in the following description, the first server 1a and the second server 1b are collectively referred to as a server 1.

Moreover, a configuration of the content delivery system 6 is not limited to an example shown in FIG. 2. For example, the content delivery system 6 may include the server 1 of three or more, or may include the client 2 of two or more. Additionally, the content delivery system 6 may include the proxy 3 of two or more. Furthermore, the content delivery system 6 may not include the proxy 3, and in this case, the client 2 is directly connected to the server 1.

In the embodiment, a transmission protocol on the network in the content delivery system 6, uses HTTP which is widely used as a hyper text transfer protocol.

Additionally, content which is delivered by the server 1, is video content, and the content is ISOBFF data which is segmented. That is, in the embodiment, the content delivery system 6 delivers the content based on an MPEG-DASH standard described above.

### [Configuration of Each Device]

Next, on the basis of FIG. 1, a configuration of a main portion of the first server 1a, the second server 1b, and the client 2, will be described. FIG. 1 is a diagram illustrating an example of the configuration of the main portion of the first server 1a, the second server 1b, and the client 2. Furthermore, for convenience of the description, the proxy 3 is omitted in FIG. 1.

### (Regarding Server)

The server 1 is a content transmission device that receives an asking message (request) asking for transmission of the content from the client 2, and transmits an answer message (response) to the received asking message.

Specifically, if the request asking for the transmission of content management information (MPD) is received from the client 2, the response including the MPD of the content is transmitted to the client 2. Moreover, if the request asking for the transmission of a segment which configures the content is received from the client 2, the response including the segment is transmitted to the client 2.

Furthermore, the server 1 obtains MPD data and segment data from the MPD storage device 4 and the segment storage device 5 on a network 7, but is not limited thereto. For example, each server 1 may locally retain the MPD data and the segment data.

As shown in FIG. 1, the first server 1a has a first server control section 11a, a first server storage section 12a, and a first server communication section 13a. Additionally, the first server control section lla is configured to include a content obtainment section 21a, a content transmission section 22a, a throughput measurement section 23a, and an event information addition section 24a, as a functional block.

Moreover, the second server 1b is configured in the same manner as the first server 1a, and has a second server control section 11b, a second server storage section 12b, and a second server communication section 13b.

Additionally, the second server control section llb is configured to include a content obtainment section 21b, a content transmission section 22b, a throughput measurement section 23b, and an event information addition section 24b, as a functional block.

In the following description, the first server control section 11a and the second server control section llb, the first server storage section 12a and the second server storage section 12b, and the first server communication section 13a and the second server communication section 13b are collectively referred to as a server control section 11, a server storage section 12, and a server communication section 13. Moreover, the content obtainment sections 21a and 21b, the content transmission sections 22a and 22b, the throughput measurement sections 23a and 23b, and the event information addition sections 24a and 24b are collectively referred to as a content obtainment section 21, a content transmission section (transmission unit) 22, a throughput measurement section (throughput measurement unit) 23, and an event information addition section (information generation unit) 24.

The server communication section 13 performs the communication to another devices such as the client 2, the MPD storage device 4, and the segment storage device 5, by a wireless communication unit or a wire communication unit, and performs an exchange of the data, according to an instruction of the server control section 11.

The server control section 11 performs various types of calculations, by executing a program which is read out into a temporary storage section (not shown) from the server storage section 12, and generally controls each of the sections which are included in the server 1.

A CPU (central processing unit) reads out and executes the program that is stored in a storage device which is realized by a ROM (read only memory), into the temporary storage section which is realized by a RAM (random access memory), and thereby, the respective functional blocks (21 to 24) of the server control section 11 can be realized.

The content obtainment section 21 obtains the MPD data from the MPD storage device 4, or the segment data from the segment storage device 5, on the basis of the instruction from the content transmission section 22. When the content obtainment section 21 obtains the MPD data, the content obtainment section 21 outputs the obtained MPD data to the content transmission section 22, and when the content obtainment section 21 obtains the segment data, the content obtainment section 21 outputs the obtained segment data to the event information addition section 24.

Furthermore, the content obtainment section 21 may obtain the MPD data and/or the segment data in advance, regardless of presence or absence of the instruction of the content transmission section 22. In this case, the content obtainment section 21 stores the MPD data and the segment data which are obtained in advance, in the server storage section 12, and reads out the MPD data and the segment data from the server storage section 12, on the basis of the instruction from the content transmission section 22.

If the content transmission section 22 receives the request from the client 2, the content transmission section 22 transmits the response with respect to the request, to the client 2. Specifically, if the request asking for the transmission of the content management information (MPD) is received from the client 2, the content transmission section 22 instructs the content obtainment section 21 to obtain the MPD of the content, and if the MPD data is obtained from the content obtainment section 21, the content transmission section 22 transmits the response including the obtained MPD data to the client 2. Moreover, if the request asking for the transmission of the segment which configures the content, is received from the client 2, the content transmission section 22 instructs the content obtainment section 21 to obtain the segment, and if the segment data is received from the event information addition section 24, the content transmission section 22 transmits the response including the segment data to the client 2.

The throughput measurement section 23 measures a throughput of the server 1. The throughput measurement section 23 may measure the actual throughput (absolute value), or may measure the relative throughput (activity ratio of the CPU, or the like). Alternatively, the throughput measurement section 23 may measure the number of the request from the client, as a throughput. The throughput measurement section 23 notifies the measured throughput to the event information addition section 24.

When the throughput which is notified from the throughput measurement section 23, is a predetermined value or more, the event information addition section 24 adds event information to the segment data which is obtained from the content obtainment section 21, and outputs the added segment data to the content transmission section 22. On the other hand, when the throughput which is notified from the throughput measurement section 23, is less than the predetermined value, the event information addition section 24 outputs the segment data which is obtained from the content obtainment section 21 intactly to the content transmission section 22.

The details thereof will be described later, but when the event information addition section 24 adds the event information to the segment data, the event information addition section 24 may add the event information to a segment data main body in a box form which is defined by ISO/IEC 14496-12 (ISOBFF) (for example, add (insert) the event information to a header portion of the segment data), or may add the event information to an HTTP header of an HTTP response message which transmits the segment data main body.

Moreover, the event information which is added by the event information addition section 24, may be server switching instruction information (obtainment destination switching instruction information) in which the obtainment destination server of the content is (forcibly) switched to the client 2, or may be load state information simply indicating the throughput of the server 1. Still more, the event information may include alternative server information indicating an alternative server, in addition to the server switching instruction information, or the load state information.

Additionally, the event information addition section 24 may generate contents of the server switching instruction information, depending on the throughput which is notified from the throughput measurement section 23. For example, the throughput of the predetermined value or more, is assumed to be divided into three regions of a high load state A, a high load state B, and a high state load C (it is assumed to be high load state A >high load state B >high load state C). In this case, if the throughput is the high load state A, the event information addition section 24 interrupts the present request, and may generate the server switching instruction information instructing immediately the switching of the server 1. If the throughput is the high load state B, the event information addition section 24 may generate the server switching instruction information instructing the switching of the server 1 from the request of the following segment, and if the throughput is the high load state C, the event information addition section 24 may generate the server switching instruction information instructing the switching of the server 1 from the request of the following period.

Furthermore, in a case of generating the load state information as event information, if the throughput is the high load state A, the event information addition section 24 may generate the load state information indicating the high load state A. If the throughput is the high load state B, the event information addition section 24 may generate the load state information indicating the high load state B, and if the throughput is the high load state C, the event information addition section 24 may generate the load state information indicating the high load state C.

The server storage section 12 stores the program or the data to which the server control section 11 refers, and may store, for example, the MPD data and the segment data which are obtained by the content obtainment section 21.

### (Regarding Client)

The client 2 is a content playback device that plays back the content which is obtained from another device such as the server 1, or the content which is stored in the client 2. For example, the client 2 is a digital television, a recorder, an STB (Set Top Box), a PC, a mobile phone, a game machine, a PDA (Personal Digital Assistant), a digital camera, a digital video, or the like.

As shown in FIG. 1, the client 2 includes a client control section 41, a client storage section 42, a client communication section 43, a display section 44, and a sound output section 45. Furthermore, the client 2 may include members such as an operation section and a sound input section, but, since there is no relation to feature points of the invention, the members are not shown in the drawing.

The client communication section 43 performs the communication with another devices such as the server 1 and the proxy 3, by the wireless communication unit or the wire communication unit, and performs the exchange of the data, according to the instruction of the client control section 41.

The display section 44 displays an image according to the instruction of the client control section 41. As long as the image is displayed according to the instruction of the client control section 41, the display section 44 is favorable. For example, an LCD (liquid crystal display), an organic EL display, a plasma display, or the like can be applied thereto.

The sound output section 45 receives an electrical signal from the client control section 41, converts the received electrical signal into a sound, and outputs the sound to the outside of the client 2. The sound output section 45 is a so-called speaker.

The client control section 41 performs various types of calculations, by executing the program which is read out into the temporary storage section (not shown) from the client storage section 42, and generally controls each of the sections which are included in the client 2.

In the embodiment, the client control section 41 is configured to include a content obtainment section (obtainment unit) 51, a reception condition measurement section 52, a content analysis section 53, a switching determination section 54, and a content playback section 55, as a functional block. The CPU reads out and executes the program that is stored in the storage device which is realized by the ROM, into the temporary storage section which is realized by the RAM, and thereby, the respective functional blocks (51 to 55) of the client control section 41 can be realized.

The content obtainment section 51 transmits the request to the server 1 through the client communication section 43, and obtains the content (the MPD which is associated with the content, and the segment which configures the content) from the server 1.

Specifically, if an obtainment (playback) instruction of the content is input from a user through the operation section (not shown), the content obtainment section 51 transmits the request asking for the transmission of the content management information (MPD), to the server 1. Therefore, the content obtainment section 51 receives the MPD data of the content, as a response of the request. The content obtainment section 51 refers to the received MPD data, and transmits the request asking for the transmission of the segment which configures the content, to the server 1. Therefore, the content obtainment section 51 obtains the segment data of the content, as a response of the request. The content obtainment section 51 outputs the obtained segment data, to the content analysis section 53 and the content playback section 55.

The reception condition measurement section 52 measures a reception condition of the data which is received by the client communication section 43. The reception condition measurement section 52 notifies the measured reception condition, to the switching determination section 54.

If the content analysis section 53 obtains the segment data from the content obtainment section 51, the content analysis section 53 analyzes the obtained segment data. In the case of adding the event information to the segment data, the content analysis section 53 extracts the event information which is added to the segment data. The content analysis section 53 outputs the extracted event information, to the switching determination section 54.

If the switching determination section 54 receives the reception condition from the reception condition measurement section 52, the switching determination section 54 determines whether or not the reception condition is favorable. Furthermore, when the switching determination section 54 determines that the reception condition is not favorable, the switching determination section 54 determines whether or not the event information is received from the content analysis section 53. When the event information is not received, the switching determination section 54 determines that a cause of deterioration of the reception condition is a band lack of the network, and instructs the content obtainment section 51 to obtain the segment of lower quality. On the other hand, when the event information is received, the switching determination section 54 determines that the reception condition deteriorates since the server 1 is in the high load state, and instructs the content obtainment section 51 to change the server 1 of the obtainment destination of the content.

Moreover, when the alternative server information is included in the event information, the switching determination section 54 instructs the content obtainment section 51 to change the obtainment destination of the content into the server 1 which is indicated in the alternative server information.

When the event information is the load state information, the switching determination section 54 may freely decide whether or not the server 1 of the obtainment destination of the content is changed, with respect to the content obtainment section 51, and which timing the server 1 is changed at. For example, even when the load state information (event information) is received, the switching determination section 54 may not instruct the content obtainment section 51 to change the server 1 of the obtainment destination of the content. Additionally, in a case of generating a random number value, and receiving the load state information, only when the generated random number value is the predetermined value, the switching determination section 54 may instruct the content obtainment section 51 to change the server 1 of the obtainment destination of the content. Moreover, when the load state information indicating the high load state C is received, the switching determination section 54 interrupts the present request, and may instruct the content obtainment section 51 to immediately switch the server.

Regardless of the reception condition, the switching determination section 54 determines whether or not the event information is added to segment data, and thereby, may instruct the content obtainment section 51 to change the server 1 of the obtainment destination of the content.

If the segment data is obtained from content obtainment section 51, the content playback section 55 refers to the MPD data, and plays back the content on the basis of the obtained segment data.

The client storage section 42 stores the program or the data to which the client control section 41 refers, and may store, for example, the MPD data and the segment data which are obtained by the content obtainment section 51.

### [Processing of Server]

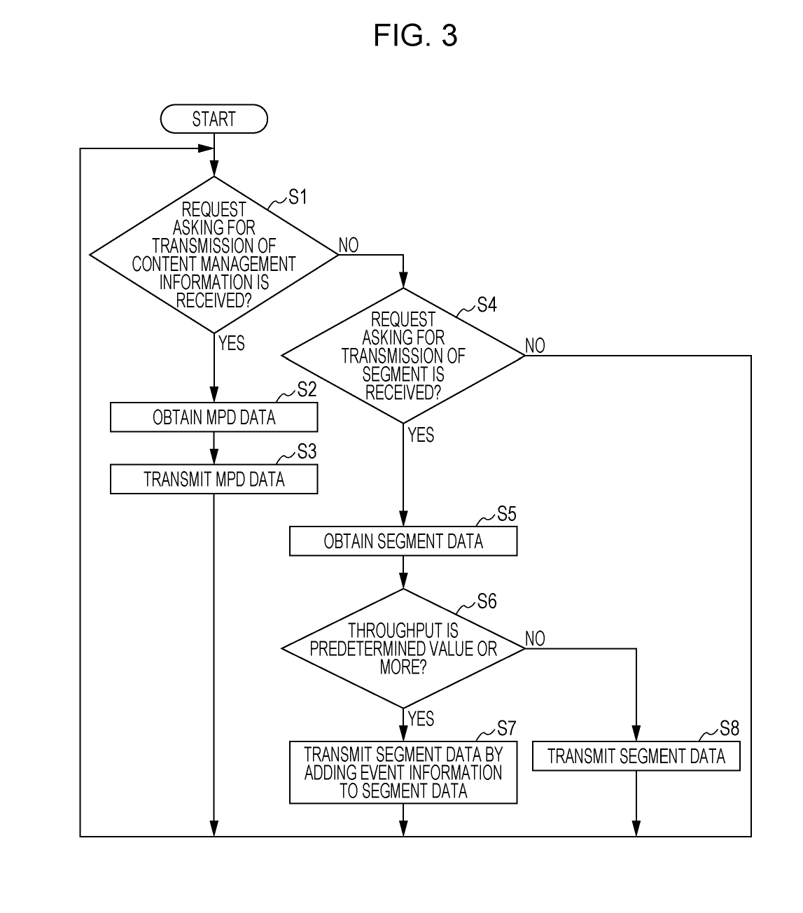

Next, content transmission processing of the server 1 will be described on the basis of FIG. 3. FIG. 3 is a flowchart illustrating an example of the content transmission processing of the server 1.

As shown in FIG. 3, the server 1 waits that the request is transmitted from the client 2 (S1, S4). Here, when the content transmission section 22 receives the request asking for the transmission of the content management information (MPD) from the client 2 (YES in S1), the content transmission section 22 instructs the content obtainment section 21 to obtain the MPD that is associated with the content which is indicated in the received request.

The content obtainment section 21 which receives the instruction from the content transmission section 22, obtains the MPD data from the MPD storage device 4, through the server communication section 13 (S2). The content obtainment section 21 outputs the obtained MPD data, to the content transmission section 22. Therefore, the content transmission section 22 transmits the response including the MPD data which is obtained from the content obtainment section 21, to the client 2 (S3).

Moreover, when the content transmission section 22 receives the request asking for the transmission of the segment from the client 2 (YES in S4), the content transmission section 22 instructs the content obtainment section 21 to obtain the segment which is indicated in the received request.

The content obtainment section 21 which receives the instruction from the content transmission section 22, obtains the segment data from the segment storage device 5, through the server communication section 13 (S5). The content obtainment section 21 outputs the obtained segment data, to the event information addition section 24.

If the segment data is obtained from the content obtainment section 21, the event information addition section 24 determines whether or not the throughput which is notified from the throughput measurement section 23 is the predetermined value or more (S6). When the throughput is the predetermined value or more (YES in S6), the event information addition section 24 adds the event information to the obtained segment data, and outputs the added segment data to the content transmission section 22, and the content transmission section 22 obtains the segment data to which the event information is added, from the event information addition section 24, and transmits the response including the segment to which the event information is added, to the client 2 (S7). On the other hand, when the throughput is less than the predetermined value (No in S6), the event information addition section 24 outputs the obtained segment data intactly to the content transmission section 22, and the content transmission section 22 transmits the response including the segment data which is obtained from the event information addition section 24, to the client 2 (S8).

### [Processing of Client]

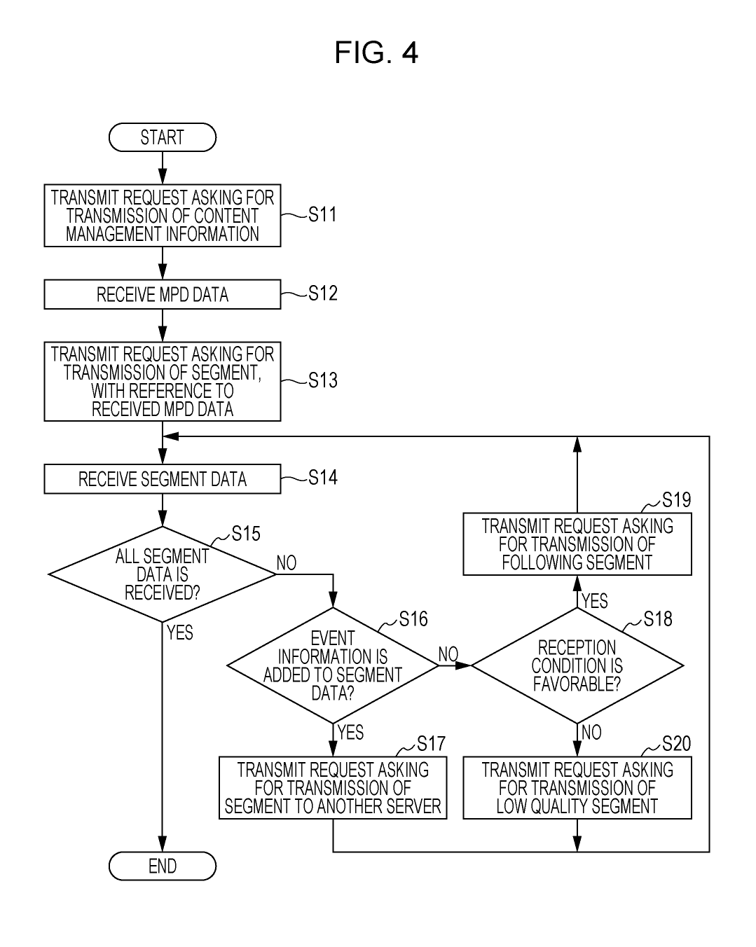

Next, content obtainment processing of the client 2 will be described on the basis of FIG. 4. FIG. 4 is a flowchart illustrating an example of the content obtainment processing of the client 2. Here, first, the client 2 transmits the request to the first server 1a, and in a case of switching the server 1, it is assumed to be switched to the second server 1b.

As shown in FIG. 4, first, the content obtainment section 51 transmits the request asking for the transmission of the content management information (MPD) to the first server 1a (S11). Therefore, the content obtainment section 51 receives the response with respect to the request, and obtains the MPD data which is included in the response (S12).

Next, the content obtainment section 51 refers to the received MPD data, and transmits the request asking for the transmission of the segment which configures the content, to the first server 1a (S13). Therefore, the content obtainment section 51 receives the response with respect to the request, and obtains the segment data which is included in the response (S14).

Here, when all of the segments which configure the content are not received (NO in S15), the switching determination section 54 determines whether or not the event information is received from the content analysis section 53, that is, whether or not the event information is added to segment data (S16). When the event information is added to the segment data (YES in S16), the switching determination section 54 instructs the content obtainment section 51 to change the server 1 of the obtainment destination of the content to the second server 1b. The content obtainment section 51 which receives the instruction, transmits the request asking for the transmission of the following segment, to the second server 1b (S17).

On the other hand, when the event information is not added to the segment data (NO in S16), the switching determination section 54 determines whether or not the reception condition is favorable, based on the reception condition which is notified from the reception condition measurement section 52 (S18). When the reception condition is favorable (YES in S18), the content obtainment section 51 transmits the request asking for the transmission of the following segment, to the first server 1a (S19). On the other hand, when the reception condition is not favorable (NO in S18), the switching determination section 54 instructs the content obtainment section 51 to obtain the segment of the lower quality. The content obtainment section 51 which receives the instruction, transmits the request asking for the transmission of the low quality segment which is the following segment, to the first server 1a (S20).

### EXAMPLE 1

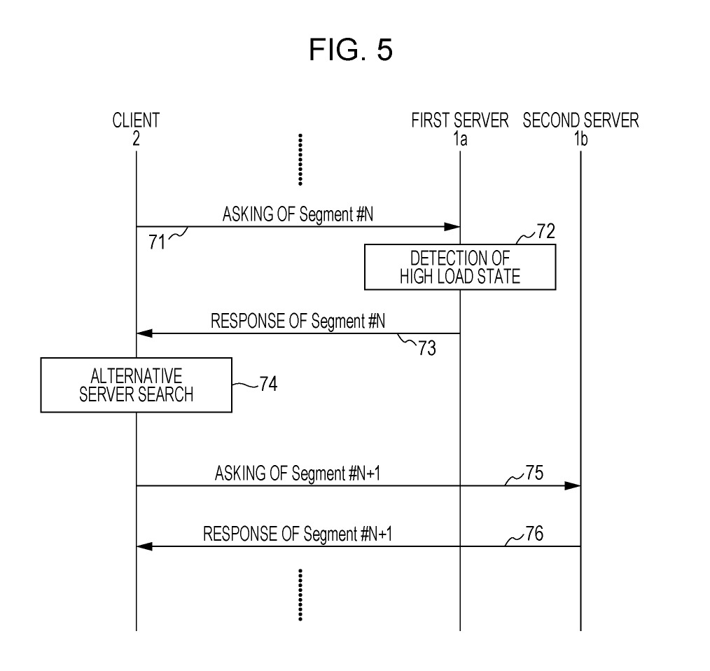

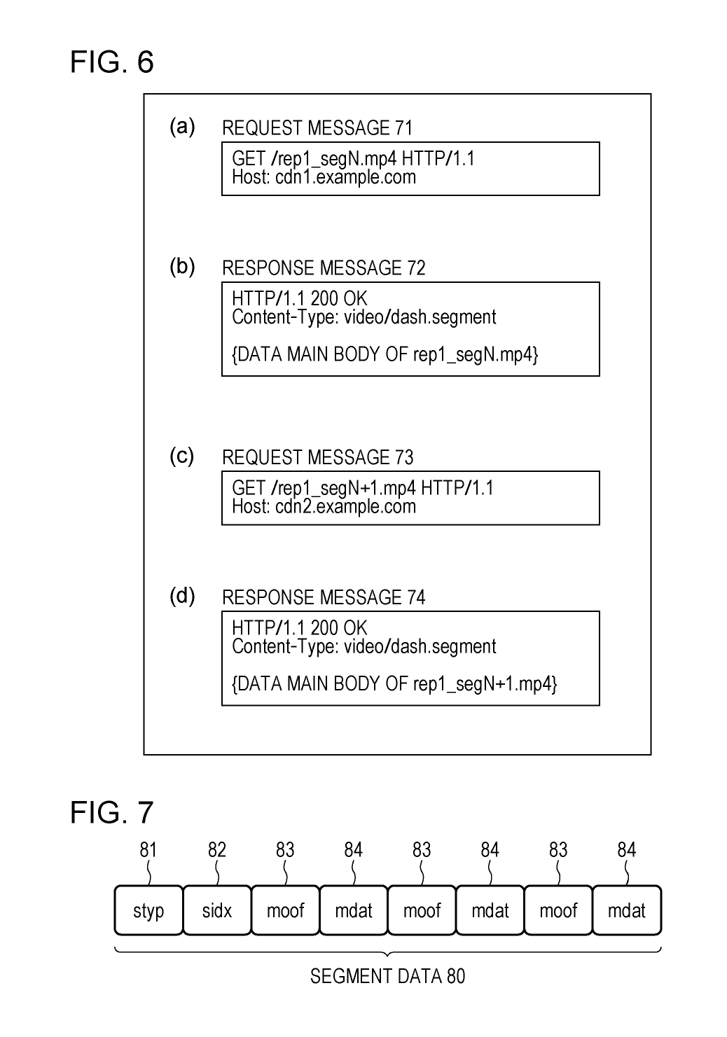

Next, a specific example of adding the event information to the segment data main body in the box form which is defined by ISOBFF, and switching to the alternative server on the basis of the event information, will be described on the basis of FIG. 5 and FIG. 6. FIG. 5 is a diagram illustrating an example of an operation sequence in a case of adding the event information to the segment data main body in the box form which is defined by ISOBFF, and switching to the alternative server on the basis of the event information. Moreover, FIG. 6 is a diagram illustrating an example of an HTTP message in the case of adding the event information to the segment data main body in the box form which is defined by ISOBFF, and switching to the alternative server on the basis of the event information.

Here, since the requests are concentrated on the first server 1a while the client 2 obtains the content from the first server 1a, it indicates the case where the first server 1a is in the high load state, and the client 2 is switched to the second server 1b from the first server 1a.

As shown in FIG. 5 and FIG. 6, the content obtainment section 51 of the client 2, refers to the MPD data, and transmits a request message 71 for asking for the transmission of an N-th segment, to the first server 1a. Here, the event information addition section 24a detects that the first server 1a is in the high load state, on the basis of the throughput which is measured by the throughput measurement section 23a (processing 72). The event information addition section 24a adds the event information, to the segment data which is obtained by the content obtainment section 21a from the segment storage device 5, in the box form which is defined by ISOBFF, and outputs the added segment data, to the content transmission section 22a. Therefore, the content transmission section 22a transmits a response message 73 including the data main body of the N-th segment to which the event information is added, to the client 2, as an answer of the request message 71.

If the content obtainment section 51 of the client 2 receives the response message 73, and obtains the segment data, the content analysis section 53 analyzes the segment data. If the content analysis section 53 analyzes the segment data, and detects the event information, the content analysis section 53 extracts the event information, and outputs the extracted event information to the switching determination section 54. Since the switching determination section 54 receives the event information, the switching determination section 54 refers to the MPD data, and executes a search of the alternative server which is different from the first server 1a (processing 74). Here, since the second server 1b is described in the MPD data, the switching determination section 54 decides the second server 1b as an alternative server, and instructs the content obtainment section 51 to change the obtainment destination of the content into the second server 1b.

The content obtainment section 51 which receives the instruction, refers to the MPD data, and transmits a request message 75 for asking for the transmission of an (N+1)-th segment to the second server 1b, to the second server 1a. Therefore, the content transmission section 22b of the second server 1b transmits a response message 76 including the data main body of the (N+1)-th segment, to the client 2, as an answer of the request message 75.

### (Data Structure of Segment Data)

Here, a data structure of the segment data where the event information is added in the box form which is defined by ISOBFF, will be described.

First, a data structure of basic segment data of related art, will be described on the basis of FIG. 7. FIG. 7 is a diagram illustrating the data structure of the segment data of the related art. As shown in FIG. 7, a segment data 80 of the related art, is configured of one styp (Segment Type Box) 81, one sidx (Segment Index Box) 82, and one set or a plurality of sets of a moof (Movie Fragment Box) 83 and a mdat (Media Data Box) 84.

The styp 81 is information indicating classification and/or version information of the segment. The sidx 82 is information relating to a random access point within the segment. The moof 83 and the mdat 84 are information relating to a fragment which configures the segment.

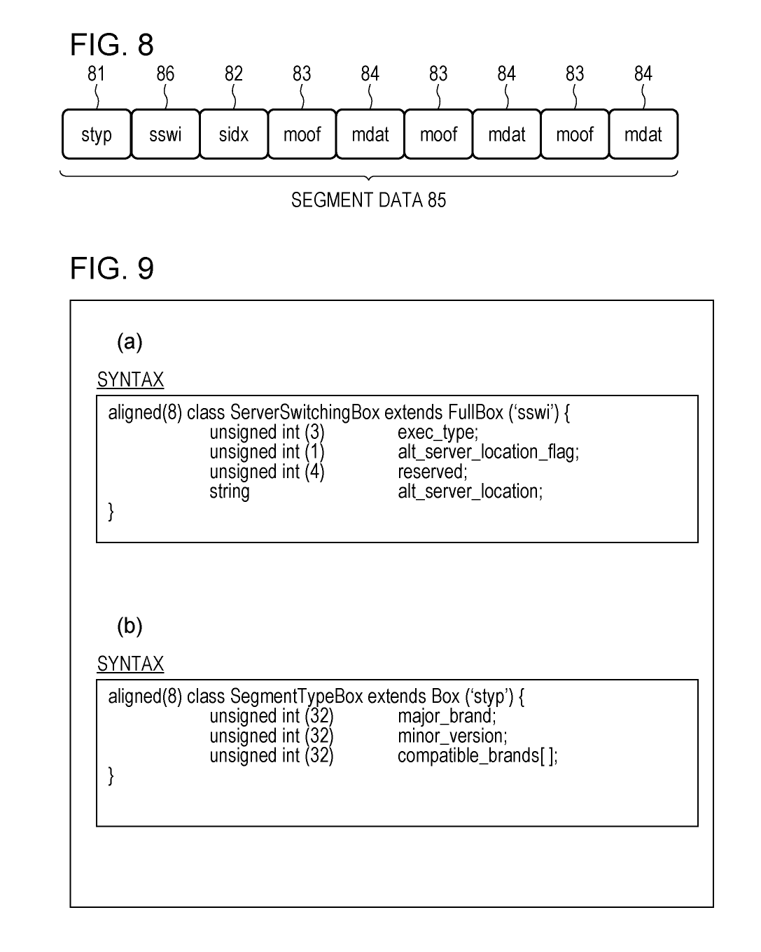

Next, the data structure of the segment data to which the event information is added, will be described on the basis of FIG. 8. FIG. 8 is a diagram illustrating the data structure of the segment data to which the event information is added. As shown in FIG. 8, a segment data 85 to which the event information is added, includes one sswi (Server Switching Box) 86, in addition to the configuration of the related art.

The sswi 86 is the event information including the server switching instruction information, or the load state information. The sswi 86 is arranged right after the styp 81, but may be arranged right after the sidx 82, or may be arranged right before or right after the moof 83 and the mdat 84 which correspond to the time of generating the event.

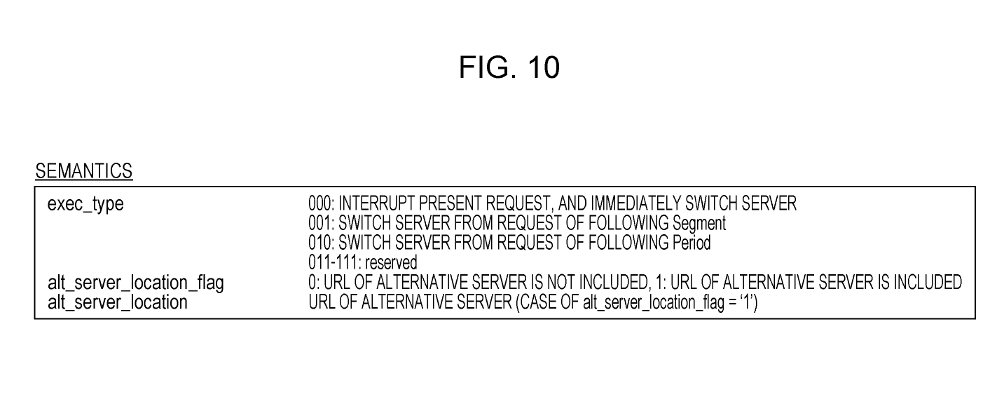

Moreover, an example of syntax and semantics of the sswi 86, will be described on the basis of FIG. 9 and FIG. 10. (a) of FIG. 9 is a diagram illustrating an example of the syntax of the sswi 86, and (b) of FIG. 9 is a diagram illustrating an example of the syntax of the styp 81. FIG. 10 is a diagram illustrating an example of the semantics of the sswi 86.

As shown in (a) of FIG. 9, in the sswi 86, “exec_type”, “alt_server_location_flag”, “reserved”, and “alt_server_location” are defined. “exec_type” is a flag of three bits, and is the server switching instruction information, or the load state information. Moreover, “alt_server_location_flag” is a flag of one bit, and indicates presence or absence of the alternative server information. Additionally, “alt_server_location” describes a character string such as URL of the alternative server. In other words, “alt_server_location_flag” and “alt_server_location” are the alternative server information.

Specifically, as shown in FIG. 10, when “exec_type” is the server switching instruction information, if a value of “exec_type” is ‘000 (binary notation)’, it is indicated that the present request is interrupted, and the switching of the server 1 is immediately instructed. Moreover, if the value is ‘001’, it is indicated that the switching of the server 1 is instructed from the request of the following segment. Still more, if the value is ‘010’, it is indicated that the switching of the server 1 is instructed from the request of the following period.

Additionally, when a value of “alt_server_location_flag” is ‘0’, it is indicated that the event information (sswi 86) does not include the URL of the alternative server (does not include the alternative server information). Moreover, when the value is ‘1’, it is indicated that the event information (sswi 86) includes the URL of the alternative server.

Alternatively, as shown in (b) of FIG. 9, ‘sswi’ as one of compatible brand is described in a compatible brands field of the styp 81, and thereby, the switching of the server may be instructed, or the high load state may be notified.

In this manner, when the event information is added to the segment data main body, since the event information is not lost on the way even in a case of going by way of the proxy ignoring the HTTP header or the like, it is possible to surely notify the event to the client.

Moreover, in MPEG-DASH, a plurality of Representations of which quality classification with respect to one content is different, are prepared, but the event information is necessarily not added to all of the Representations. Therefore, if the event information may be added to the segment data main body, the presence of the event information may be notified to the MPD in advance.

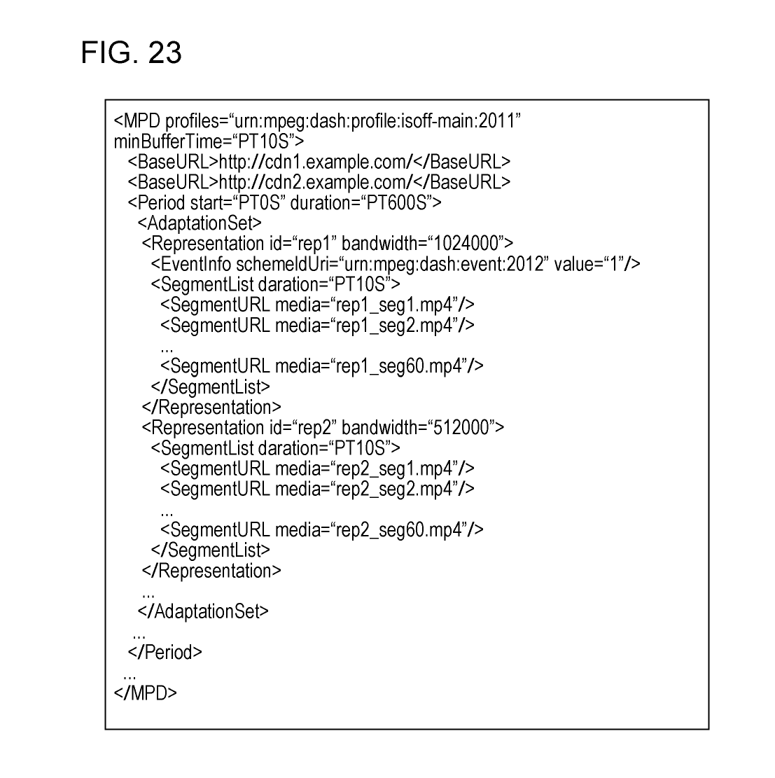

FIG. 23 is a diagram illustrating a description example of the MPD including the notification of the presence of the event information. As shown in FIG. 23, an EventInfo element indicating the presence of the event information is described within a Representation element. The EventInfo element includes a schemeIdUri attribute for identifying an event list, and a value attribute for identifying the contents of the event information which is added to the segment data main body.

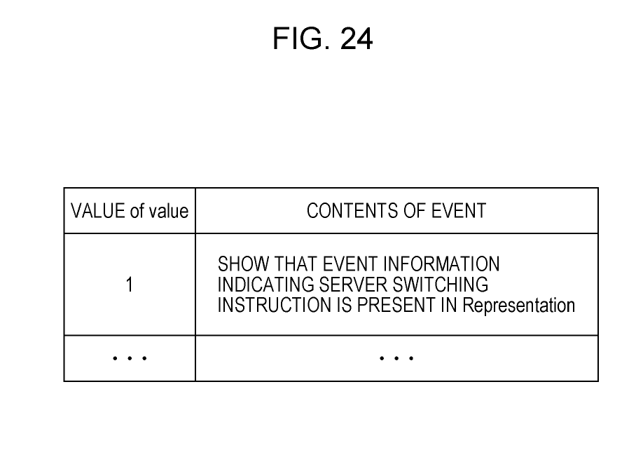

FIG. 24 is a diagram illustrating an event list which is defined by schemeIdUri=“urn:mpeg:dash:event:2012”. In a case of value=“1”, it is indicated that the event information indicating the server switching instruction is present in the Representation. Furthermore, in a case of adding the event, the value of value and the contents of the event may be defined anew to the event list.

In the description example of FIG. 23, since the EventInfo element is described in the Representation of which bit rate is 1024 kbps, it indicates a possibility of adding the event information indicating the server switching instruction. On the other hand, since the EventInfo element is not described in the Representation of which bit rate is 512 kbps, it indicates no possibility of adding the event information indicating the server switching instruction.

### EXAMPLE 2

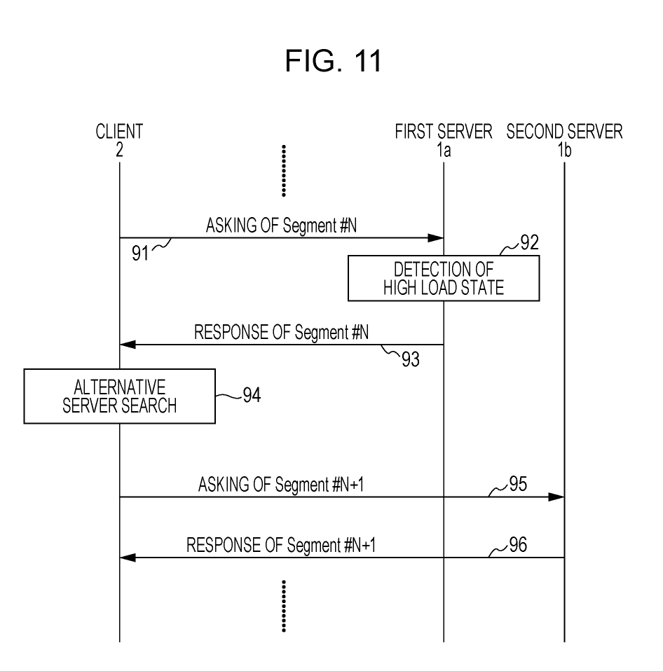

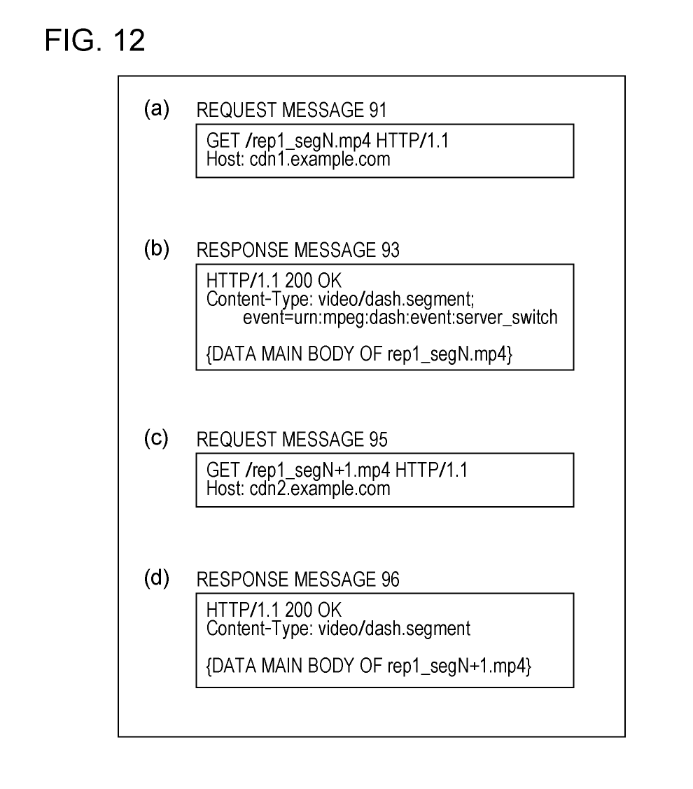

Next, a specific example of describing the event information in the HTTP header of the HTTP response message which transmits the segment data main body, and switching to the alternative server on the basis of the event information, will be described on the basis of FIG. 11 and FIG. 12. FIG. 11 is a diagram illustrating an example of an operation sequence in a case of describing the event information in the HTTP header of the HTTP response message which transmits the segment data main body, and switching to the alternative server on the basis of the event information. Moreover, FIG. 12 is a diagram illustrating an example of an HTTP message in the case of describing the event information in the HTTP header of the HTTP response message which transmits the segment data main body, and switching to the alternative server on the basis of the event information.

Here, since the requests are concentrated on the first server 1a while the client 2 obtains the content from the first server 1a, it indicates the case where the first server 1a is in the high load state, and the client 2 is switched to the second server 1b from the first server 1a.

As shown in FIG. 11 and FIG. 12, the content obtainment section 51 of the client 2 refers to the MPD data, and transmits a request message 91 for asking for the transmission of the N-th segment, to the first server 1a. Here, the event information addition section 24a notifies that the first server 1a is in the high load state, on the basis of the throughput which is measured by the throughput measurement section 23a (processing 92). The event information addition section 24a instructs the content transmission section 22a so that the content obtainment section 21a describes the event information in the HTTP header of the HTTP response message transmitting the segment data main body which is obtained from the segment storage device 5. Therefore, the content transmission section 22a adds the event information as a parameter of MIME Type (media type) to a Content-Type header of the HTTP response message transmitting the segment data main body. Therefore, the content transmission section 22a transmits a response message 93 including the data main body of the N-th segment where the event information is added to the HTTP header, to the client 2, as an answer of the request message 71.

If the content obtainment section 51 of the client 2 receives the response message 93, and obtains the segment data, the content analysis section 53 analyzes the response message 93. If the content analysis section 53 analyzes the response message 93, and detects the event information from the HTTP header, the content analysis section 53 extracts the event information, and outputs the extracted event information to the switching determination section 54. Since the switching determination section 54 receives the event information, the switching determination section 54 refers to the MPD data, and executes the search of the alternative server which is different from the first server 1a (processing 94). Here, since the second server 1b is described in the MPD data, the switching determination section 54 determines the second server 1b as an alternative server, and instructs the content obtainment section 51 to change the obtainment destination of the content into the second server 1b.

The content obtainment section 51 which is received the instruction, refers to the MPD data, and transmits a request message 95 for asking for the transmission of the (N+1)-th segment to the second server 1b, to the second server 1a. Therefore, the content transmission section 22b of the second server 1b transmits a response message 96 including the data main body of the (N+1)-th segment, to the client 2, as an answer of the request message 95.

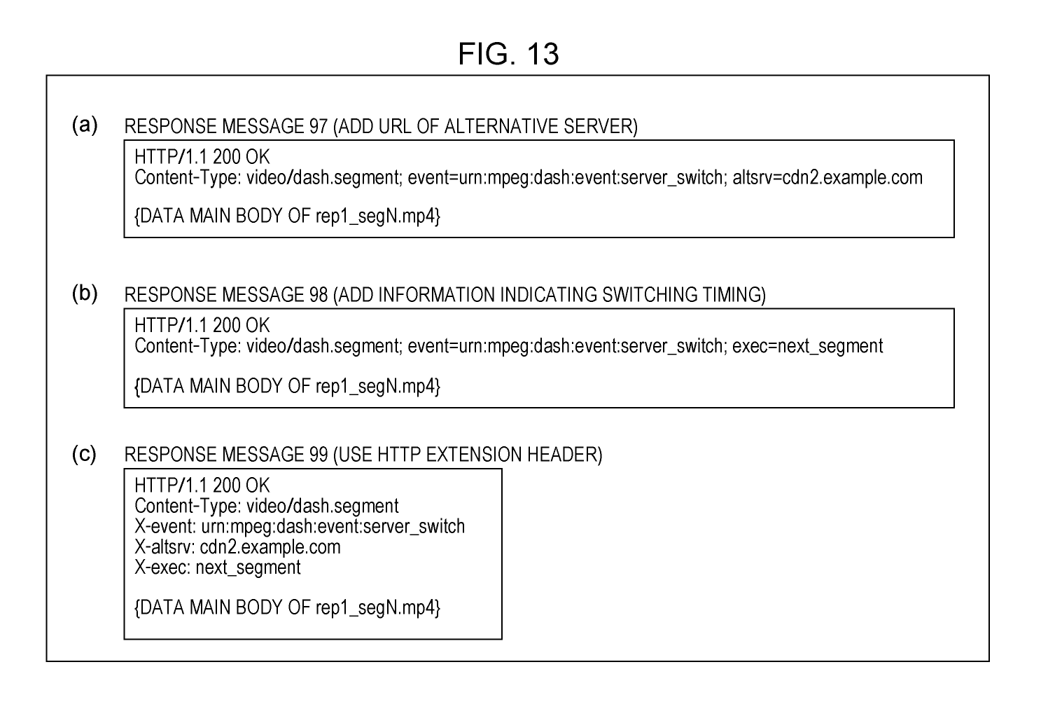

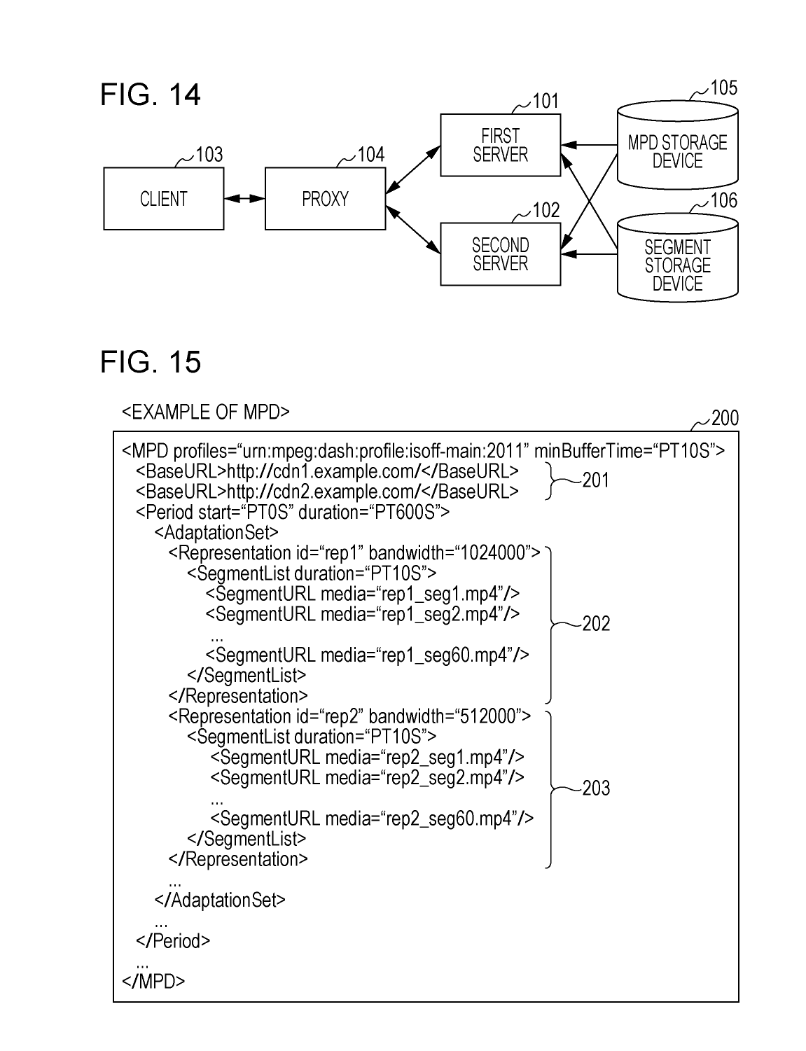

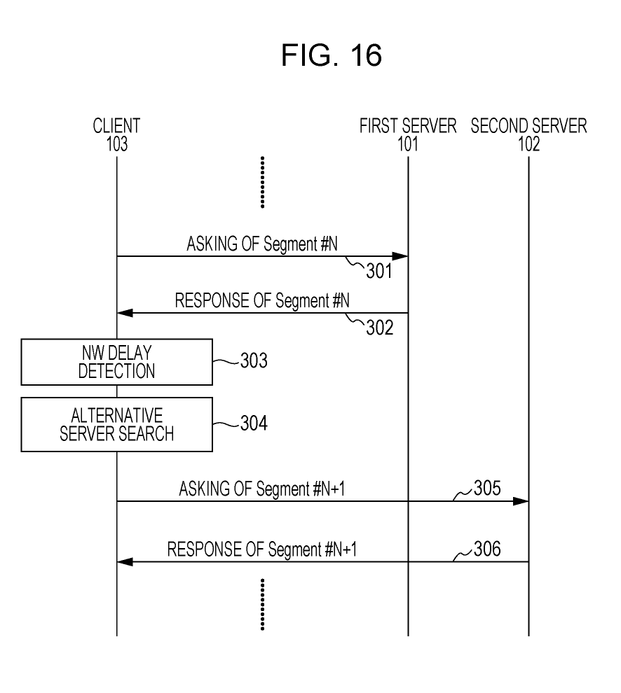

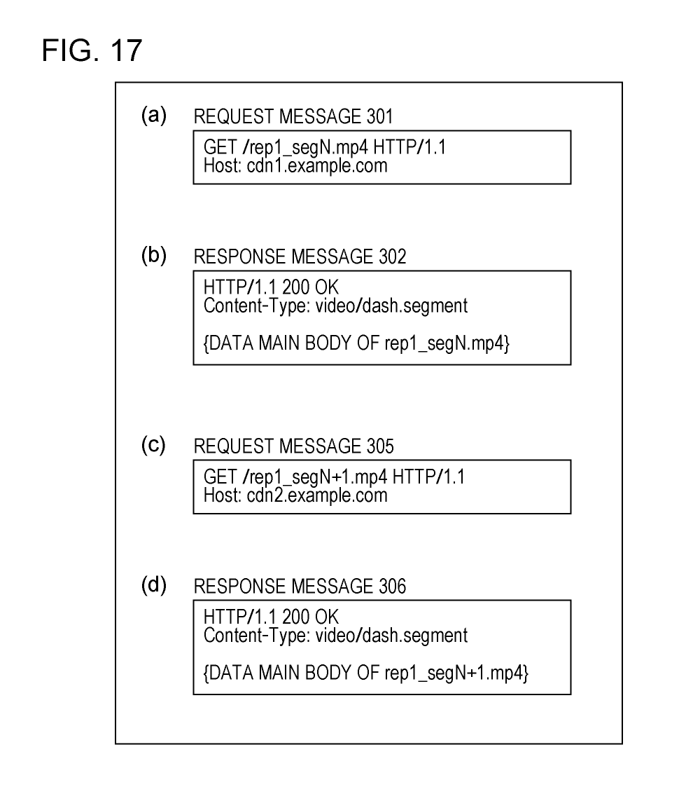

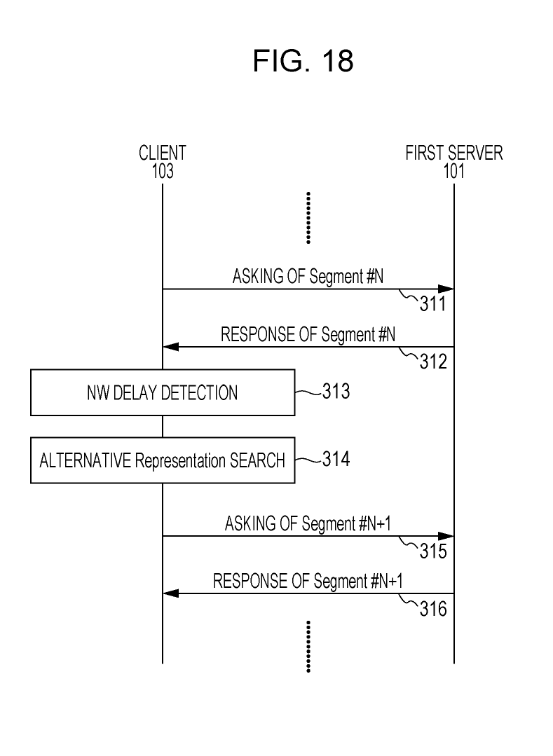

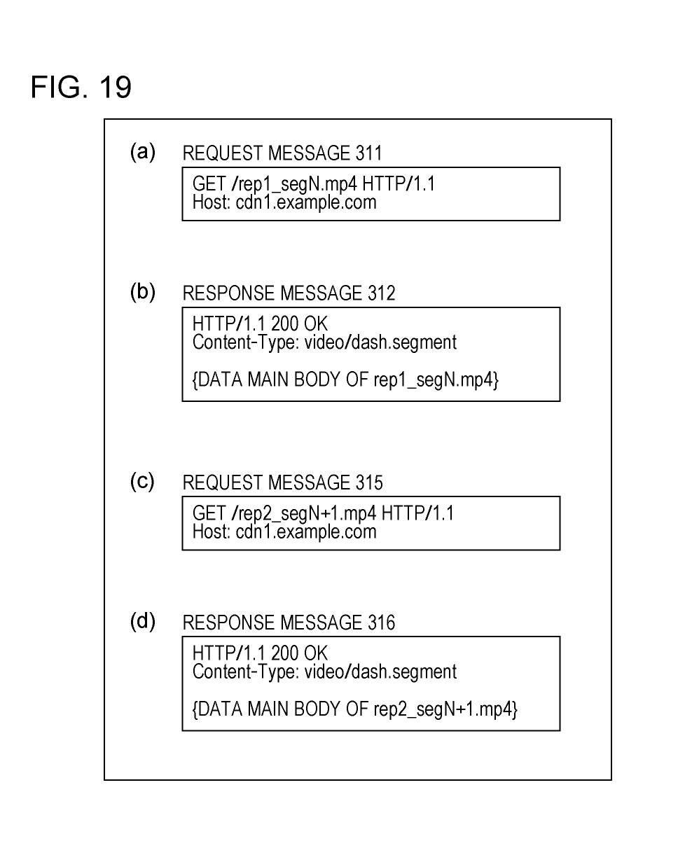

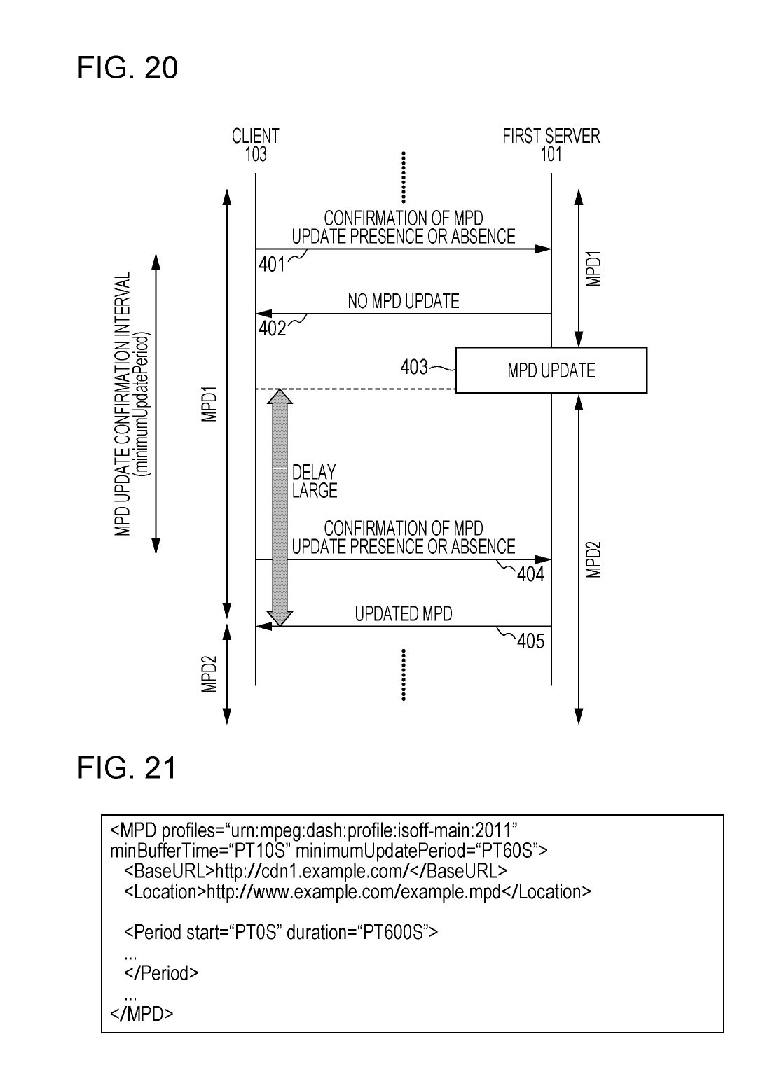

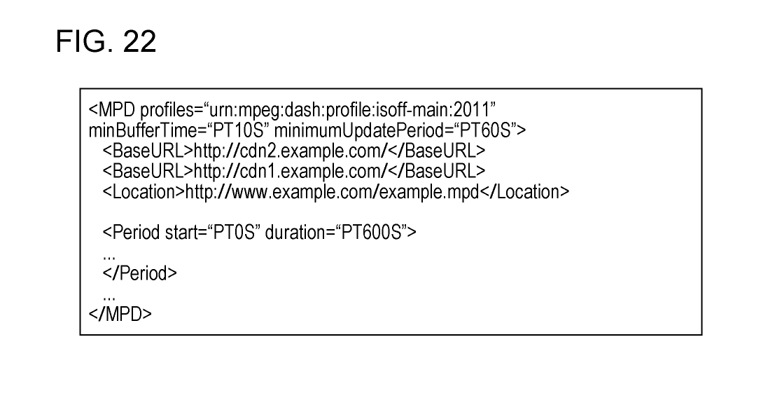

Furthermore, as a modification example, instead of the response message 93, a response message 97 shown in FIG. 13 where the URL of the alternative server is added to the HTTP header, may be transmitted.

Moreover, instead of the response message 93, a response message 98 shown in FIG. 13 where the server switching timing is added to the header, may be transmitted. In the response message 98, it is described that “exec=next_segment”, and it is indicated that the server is switched from the following segment. When “immediate” is described in the value of “exec”, it is indicated that the server is immediately switched, and when “nexp_period” is described, it is indicated that the server is switched from the following period.

Additionally, instead of the response message 93, a response message 99 shown in FIG. 13 where the event information is added using an HTTP extension header, may be transmitted.

In this manner, in the case of adding the event information to the HTTP header of the response message, it is not necessary to generate the segment to which the event information is added per Representation, even when the plurality of Representations are prepared in the server. In other words, additional processing in accordance with the event information addition does not depend on the number of Representations.

### [Supplement]

The present invention is not limited to the embodiments described above, and can be variously changed in the scope shown in the claims. That is, the embodiments that are obtained by combining technical units which are appropriately changed in the scope shown in the claims, are also included in the technical scope of the present invention.

Finally, each block of the server 1 and the client 2, particularly the server control section 11 and the client control section 41 may be configured by hardware logic, or may be realized by software using a CPU as follows.

That is, the server 1 and the client 2 include the CPU (central processing unit) executing a command of a control program which realizes each function, a ROM (read only memory) storing the program, a RAM (random access memory) developing the program, a storage device (recording medium) such as a memory storing the program and various types of data, and the like. Therefore, the recording medium where program codes (executable form program, intermediate code program, source program) of the control program of the server 1 and the client 2 which is the software realizing the functions described above, are recorded readably by a computer, is supplied to the server 1 and the client 2, and the computer (or the CPU and an MPU) reads out and executes the program codes which are recorded in the recording medium, and thereby, an object of the present invention can be achieved.

As a recoding medium described above, for example, a tape system such as a magnetic tape or a cassette tape, a disc system including a magnetic disc such as a floppy (registered trademark) disk or a hard disc, and an optical disc such as a CD-ROM, an MO, an MD, a DVD, or a CD-R, a card system such as an IC card (including a memory card) or an optical card, or a semiconductor memory system such as a mask ROM, an EPROM, an EEPROM (registered trademark), or a flash ROM, can be used.

Moreover, the server 1 and the client 2 are configured to be connectable to a communication network, and the program codes may be supplied through the communication network. As a communication network, it is not limited in particular, and for example, the Internet, an intranet, an extranet, a LAN, an ISDN, a Van, a CATV communication network, a virtual private network, a telephone line network, a mobile body communication network, a satellite communication network, or the like is usable. Additionally, as a transmission medium configuring the communication network, it is not limited in particular, and for example, the wire such as an IEEE 1394, a USB, a power-line carrier, a cable TV circuit, a telephone line, or an ADSL circuit, infrared rays such as an IrDA or a remote controller, the wireless such as Bluetooth (registered trademark), 802.11 wireless, an HDR, a mobile phone network, a satellite circuit, or a terrestrial digital network, or the like are usable. Furthermore, the present invention can be also realized in a shape of a computer data signal in which the program codes are embodied by electronic transmission, and are embedded in a carrier wave.

### INDUSTRIAL APPLICABILITY

According to the present invention, the present invention can be used in a content transmission device which transmits content of an MPEG-DASH standard, and a content playback device which obtains and plays back the content.

### REFERENCE SIGNS LIST

1 SERVER
2 CLIENT
3 PROXY
4 MPD STORAGE DEVICE
5 SEGMENT STORAGE DEVICE
6 CONTENT DELIVERY SYSTEM
21 CONTENT OBTAINMENT SECTION
22 CONTENT TRANSMISSION SECTION (TRANSMISSION UNIT)
23 THROUGHPUT MEASUREMENT SECTION (THROUGHPUT MEASUREMENT UNIT)
24 EVENT INFORMATION ADDITION SECTION (INFORMATION GENERATION UNIT)
51 CONTENT OBTAINMENT SECTION (OBTAINMENT UNIT)
52 RECEPTION CONDITION MEASUREMENT SECTION
53 CONTENT ANALYSIS SECTION
54 SWITCHING DETERMINATION SECTION
55 CONTENT PLAYBACK SECTION

1-26. (canceled)

27. A content transmission device that transmits content which is configured of a plurality of segments to a content playback device per segment, comprising:
a transmission unit that transmits a response including the segment to the content playback device, as an answer with respect to a request asking for transmission of each segment from the content playback device;
a throughput measurement unit that measures a throughput of the content transmission device; and
an information generation unit that generates obtainment destination switching instruction information instructing to switch an obtainment destination of the content to another content transmission device, in a case of the most recent throughput which is measured by the throughput measurement unit of a predetermined value or more,
wherein in a case of generating the obtainment destination switching instruction information by the information generation unit, the transmission unit transmits the segment together with the obtainment destination switching instruction information which is generated by the information generation unit.

28. The content transmission device according to claim 27,
wherein the information generation unit adds the obtainment destination switching instruction information to a header portion of the segment.

29. The content transmission device according to claim 27,
wherein the information generation unit adds the obtainment destination switching instruction information to a header of the response.

30. The content transmission device according to claim 27,
wherein in the case of the most recent throughput which is measured by the throughput measurement unit of a predetermined value or more, the information generation unit generates the obtainment destination switching instruction information instructing a timing of switching the obtainment destination of the content to another content transmission device depending on the throughput.

31. A content transmission device that transmits content which is configured of a plurality of segments to a content playback device per segment, comprising:
a transmission unit that transmits a response including the segment to the content playback device, as an answer with respect to a request asking for transmission of each segment from the content playback device;
a throughput measurement unit that measures a throughput of the content transmission device; and
an information generation unit that generates load state information indicating that the content transmission device is in a high load state, in a case of the throughput which is measured by the throughput measurement unit of a predetermined value or more,
wherein the transmission unit transmits the segment together with the most recent load state information which is generated by the information generation unit.

32. The content transmission device according to claim 31,
wherein the information generation unit adds the load state information to a header portion of the segment.

33. The content transmission device according to claim 31,
wherein the information generation unit adds the load state information to a header of the response.

34. The content transmission device according to claim 31,
wherein in the case of the throughput which is measured by the throughput measurement unit of a predetermined value or more, the information generation unit generates the load state information indicating a degree of the high load state of the content transmission device, depending on the throughput.

35. A content playback device that obtains and plays back content which is configured of a plurality of segments from a content transmission device per segment, comprising:
an obtainment unit that transmits a request asking for transmission of each segment to the content transmission device, and obtains a response including the segment, as an answer with respect to the request,
wherein in a case of obtaining obtainment destination switching instruction information instructing to switch an obtainment destination of the content to another content transmission device, the obtainment unit transmits the segment together with the request with respect to another content transmission device.

36. The content playback device according to claim 35,
wherein in a case of adding the obtainment destination switching instruction information to a header portion of the segment, the obtainment unit transmits the request to another content transmission device.

37. The content playback device according to claim 35,
wherein in a case of adding the obtainment destination switching instruction information to a header of the response, the obtainment unit transmits the request to another content transmission device.

38. The content playback device according to claim 35,
wherein in a case of instructing a timing of switching the obtainment destination of the content to another content transmission device by the obtainment destination switching instruction information, the obtainment unit transmits the request to another content transmission device at the instructed timing.

39. A content delivery system including the content transmission device according to claim 27, and a content playback device that obtains and plays back content which is configured of a plurality of segments from a content transmission device per segment,
the content playback device comprising:
an obtainment unit that transmits a request asking for transmission of each segment to the content transmission device, and obtains a response including the segment, as an answer with respect to the request,
wherein in a case of obtaining obtainment destination switching instruction information instructing to switch an obtainment destination of the content to another content transmission device, the obtainment unit transmits the segment together with the request with respect to another content transmission device.
